(19) United States
(12) Patent Application Publication
(10) Pub. No.: US 2025/0347338 A1
(43) Pub. Date: Nov. 13, 2025

(54) Toothed Belt Pulley with Improved Mesh and Belt Drive, Bicycle and Kit

(71) Applicant: Karlheinz NICOLAI, Duingen Lübbrechtsen (DE)

(72) Inventor: Karlheinz NICOLAI, Duingen Lübbrechtsen (DE)

(21) Appl. No.: 18/672,391

(22) Filed: May 23, 2024

(30) Foreign Application Priority Data
May 8, 2024 (DE) 102024113010.5

(51) Int. Cl. F16H 55/17; B62K 25/28; B62M 9/02; F16H 55/08

(52) U.S. Cl. CPC F16H 55/171; B62M 9/02; F16H 55/08; B62K 25/28

(57) ABSTRACT

A toothed belt pulley for a toothed belt with a predetermined pitch, the toothed belt pulley comprises teeth arranged along a circumferential direction of the toothed belt pulley and grooves arranged in the circumferential direction between in each case adjacent teeth of the toothed belt pulley, and the toothed belt pulley comprises a pitch which is smaller than the pitch of the toothed belt. A belt drive comprising a toothed belt pulley and a toothed belt, and a kit for a belt drive comprising at least two toothed belt pulleys for the same toothed belt of predetermined pitch. Finally, a bicycle with a toothed belt pulley and/or a belt drive is proposed.

### CROSS-REFERENCE TO RELATED APPLICATION

This application claims priority under 35 U.S.C. § 119 to German Patent Application No. 102024113010.5 filed on May 8, 2024, the disclosure of which is hereby incorporated by reference in its entirety.

### FIELD OF INVENTION

In the following, a toothed belt pulley for a toothed belt with a predetermined pitch and a belt drive with a toothed belt pulley and a toothed belt are described. The subject matter also includes a kit for a belt drive with at least two toothed belt pulleys for the same toothed belt with a predetermined pitch. Finally, a bicycle with a toothed belt pulley according to the invention and/or a belt drive according to the invention is proposed.

### BACKGROUND

In bicycles, especially electrically assisted bicycles, toothed belt drives are increasingly being used. Toothed belts and toothed belt pulleys are usually matched to each other and have the same pitch. In the case of toothed belt drives, especially with less torsion-resistant bicycle frames and high drive torques, mesh failures of the toothed belt can occur, i.e. improper meshing of the toothed belt pulley and toothed belt.

The same problem can also be found in other applications such as motorcycles or other lightweight vehicles. Whenever a toothed belt drive is attached to a flexible frame or structure in particular, the center distance can change under load and the return strand can sag considerably. The meshing failures occur when the belt runs into the toothed belt pulley.

Mesh failures of this kind can lead to injuries to the cyclist, as he or she may suddenly step into the void unexpectedly. In addition, there is an increased risk of stress peaks in the belt, which can lead to the belt breaking.

### SUMMARY

Consequently, it is in particular the object to make bicycles with belt drives safer and more reliable.

This problem is solved by a toothed belt pulley for a toothed belt with a predetermined pitch, wherein the toothed belt pulley has teeth arranged along a circumferential direction of the toothed belt pulley and grooves arranged in the circumferential direction between respectively adjacent teeth of the toothed belt pulley, and wherein the toothed belt pulley has a pitch which is smaller than the pitch of the toothed belt.

Surprisingly, a toothed belt pulley of this configuration can reliably prevent mesh failures of the toothed belt during bicycle operation. Laboratory tests have shown that when the bicycle frame is twisted, the teeth of the toothed belt have difficulties meshing properly with the grooves of a conventional toothed belt pulley. As a result, especially at the entry of the toothed belt pulley, a tooth of the belt runs up against a tooth of the driven toothed belt pulley and finally skips. The reason for this appears to be that the toothed belt pulleys of the belt drive no longer align exactly with each other when the frame is twisted and, in addition, the center distance prescribed for a toothed belt drive according to the state of the art cannot be maintained. Among other things, the center distance is shortened, which results in the return strand no longer running in a straight line but forming an arc. The impermissible arc-shaped entry of the toothed belt into the driven toothed belt pulley causes the mesh failure, which leads to the belt skipping on the driven toothed belt pulley.

Surprisingly, such a mesh failure can be avoided with a toothed belt pulley configured as above. The proposed solution improves the meshing of the toothed belt and toothed belt pulley even at high drive torques and with a twisting frame when the relative alignment and/or position of the two toothed belt pulleys of the toothed belt drive changes. This is important insofar as toothed belt drives are increasingly being used on bicycles with a long rear triangle and/or for high loads, such as cargo bikes, full-suspension frames or S-pedelecs. The solution according to the invention enables the use of lightweight and less torsion-resistant frames even with high drive power, as can be provided by bicycles with auxiliary drive. Even a single toothed belt pulley configured as above makes the toothed belt drive more tolerant of torsion and shortening of the frame.

The above solution can be further improved by the following features, each of which is preferred in its own right, independent of one another and can be combined as desired.

The pitch of the toothed belt pulley can be measured or determined as an arc length on a pitch circle diameter or in the circumferential direction of a pitch line with the pitch circle diameter. The pitch circle diameter can be calculated by adding an (actual) tip circle diameter of the toothed belt pulley and a double pitch line distance. The pitch line distance can be predetermined by the technical design of the belt. The pitch line can extend along or correspond to a tensile fiber of the toothed belt.

According to one configuration, the pitch of the toothed belt pulley can be smaller than the (predetermined) pitch of the toothed belt by a pitch correction value. The pitch correction value can depend on at least one parameter that determines or characterizes the profile geometry of the toothed belt and/or the profile geometry of the toothed belt pulley. For example, the pitch correction value may depend on at least one parameter from the group of parameters comprising a tip circle diameter of the toothed belt pulley; the pitch of the toothed belt pulley; the predetermined pitch of the toothed belt; a predetermined distance of the tooth root of the toothed belt from a tensile member of the toothed belt; and a tooth height of the toothed belt. Of course, the group of parameters can also include other parameters. For example, the pitch correction value can also depend on the number of teeth of the toothed belt pulley and/or the wrap angle.

The toothed belt can be configured in accordance with a standard, in particular the ISO 13050 standard. The ISO 13050 standard can be understood to mean the version ISO 13050:2022. Throughout this document, a reference to the ISO 13050 standard includes a reference to the sections or chapters of the ISO 13050 standard relating to the profile system H.

It has proven to be particularly advantageous for avoiding mesh failures if, in a preferred configuration, the pitch of the toothed belt pulley is smaller than the pitch of the toothed belt by at least 0.5% and at most 2.5% of the pitch of the toothed belt. Further and preferably, the pitch of the toothed belt pulley can be smaller than the pitch of the toothed belt by at least 1.0% and at most 2.0% of the pitch of the toothed belt.

According to a further preferred configuration, which reliably avoids mesh failures, the pitch of the toothed belt pulley can be between approximately 97.5% and 99.5%, further and preferably between approximately 99% and 98% of the pitch of the toothed belt. The term “approximately” can mean a deviation of 10%. Above, the pitches can be understood as the numerical values for the pitches.

In order to implement the reduced pitch of the toothed belt pulley compared to the pitch of the toothed belt in a structurally simple manner, the toothed belt pulley can, according to a preferred embodiment, comprise an (actual) tip circle diameter that is smaller than the tip circle diameter specified by the profile geometry of the toothed belt. The terms “tip circle diameter”, “running diameter” or “outside diameter” can be used synonymously.

The tip circle diameter specified by the profile geometry of the toothed belt can be specified by a standard and/or a norm. In particular, the tip circle diameter specified by the profile geometry of the toothed belt can be specified by the ISO 13050 standard and/or correspond to the tip circle diameter of a toothed belt pulley dimensioned in accordance with the ISO 13050 standard. The toothed belt pulley, which has the tip circle diameter specified by the profile geometry, can be configured according to the same standard and/or according to the same norm, for example according to ISO 13050, as the toothed belt with the specified pitch with which the toothed belt pulley according to the invention is or is to be used as intended.

To avoid reducing the width of the grooves despite the reduced pitch of the toothed belt pulley compared to the pitch of the toothed belt, the teeth of the toothed belt pulley can, according to a preferred configuration, be less wide than the teeth specified by the profile geometry of the toothed belt, at least in sections along the circumferential direction.

The width of a groove or tooth is to be understood here as an extension in the circumferential direction. The (actual) width in the circumferential direction of the teeth of the toothed belt pulley and the (theoretical) width in the circumferential direction of the teeth specified by the profile geometry of the toothed belt can thereby be determined at the height of the same radius or diameter.

In order to make it easier for the teeth of the toothed belt to enter the grooves of the toothed belt pulley and thus to mesh, the grooves of the toothed belt pulley can comprise a width in the circumferential direction that is greater than a groove width specified by the profile geometry of the toothed belt, at least in the area of the tooth roots of the teeth of the toothed belt pulley.

The comparison of the (actual) width of the grooves of the toothed belt pulley with the (theoretical) width of the grooves specified by the profile geometry of the toothed belt can be made in relation to the same radius. Thus, the (actual) width of the grooves of the toothed belt pulley can be measured at the height of the same radius as the (theoretical) width of the grooves specified by the profile geometry of the toothed belt.

The grooves of the toothed belt pulley can be widened along the circumferential direction compared to the grooves of a standard toothed belt pulley dimensioned according to ISO 13050, at least in the area of the tooth roots of the teeth of the toothed belt pulley, in particular at the height of a root circle of the toothed belt pulley. Alternatively or cumulatively, the teeth of the toothed belt pulley can be narrower than the teeth of a standard toothed belt pulley dimensioned according to ISO 13050, at least in the area of the tooth roots of the teeth of the toothed belt pulley.

The term “grooves” used here can correspond to the terms “grooves” or “pulley grooves” used in the ISO 13050 standard.

According to a further preferred embodiment, at least one groove of the toothed belt pulley can be asymmetrical with respect to a radial plane running through the point of the respective groove lying on the smallest diameter. Grooves that are asymmetrical in such a way take into account the fact that different functional requirements are placed on the shape of the tooth flanks. For example, it can be advantageous if a tooth flank configured for force transmission with the toothed belt, which is arranged in one area of the groove divided by the radial plane, is configured differently from a tooth flank not configured for force transmission with the toothed belt, which is arranged in the other area of the groove divided by the radial plane.

The radial plane divides the groove into two areas, which in this case are not symmetrical to each other. The two areas are located on both sides of the radial plane. The radial plane passes through the center of the toothed belt pulley and extends in a radial and axial direction. Radii and diameters are calculated or measured from the center of the toothed belt pulley.

The point of the toothing of the toothed belt pulley or a groove of the toothing of the toothed belt pulley lying on the smallest diameter can also be designated as the radially innermost point of a groove and/or the radially deepest point of a groove. The point lying on the smallest diameter can also be designated as the point lying on the smallest radius. The points lying on the smallest diameter or the innermost points do not necessarily have to be a single point respectively, but can also comprise several points or a section of the groove extending in particular in the circumferential direction. If the deepest point is such a section, the radial plane can run centrally through the section of the groove that represents the innermost point with respect to the circumferential direction.

The point lying on the smallest diameter of a groove can designate a groove root of the grooves. If the groove root has no apex or several apexes, the radial plane can run centrally through the groove root with respect to the circumferential direction.

The asymmetry of a groove can result from the fact that one or more parameters describing the geometry of the groove have a different value in one area of the groove divided by the radial plane than in the other area of the groove divided by the radial plane. In the area divided by the radial plane, the groove has a different shape than in the other area divided by the radial plane.

In this case, the two areas of the groove separated by the radial plane can be compared with each other at the height of the same diameter.

Some parameters that describe or determine the geometry of the groove are explained below.

In one configuration, the tooth flank in one area divided by the radial plane can thus comprise a different shape than the tooth flank in the other area divided by the radial plane. For example, the tooth flanks in the areas separated from each other by the radial plane can have a different steepness. Such a configuration makes it more difficult for the teeth of the toothed belt to run up the steeper tooth flank of the toothed belt pulley. This ensures secure mesh between the teeth of the toothed belt pulley and the teeth of the toothed belt.

The differently steep sections of the tooth flanks in the two areas divided from each other by the radial plane can extend over the entire tooth height or only a part of the tooth height of the respective tooth. Thus, the differently steep sections of the areas of a groove separated from each other by the radial plane can extend from a first diameter to a second diameter. One of the two diameters can be, for example, a root circle diameter of the toothed belt pulley, a tip circle diameter of the toothed belt pulley or any diameter located between the root circle diameter and the tip circle diameter. The diameter located between the root circle radius and the tip circle radius can, for example, extend to the height of half the tooth height of a tooth of the toothed belt pulley.

The steepness of the tooth flank is preferably determined relative to the radial direction at the relevant point of the tooth flank. The smaller the angle to the radial direction, the steeper the tooth flank.

The tooth flank in the one area of the groove divided by the radial plane can comprise a first tooth flank angle and the tooth flank in the other area of the groove divided by the radial plane can comprise a second tooth flank angle that differs from the first tooth flank angle, in particular on the same diameter. In particular, the tooth flank angles of the tooth flanks can be differently acute or differently obtuse. The second tooth flank angle is preferably approximately 0° to 1°, in particular approximately 0.5° greater or more obtuse than the second tooth flank angle. The term “approximately” can correspond to a deviation of +10%.

The tooth flank angles of the toothed belt pulley, in particular a geometric position of the tooth flank angles, can be defined in the same way as the groove angles @ of a standard toothed belt pulley dimensioned according to ISO 13050.

In order to further simplify the entry of the teeth of the toothed belt into the grooves of the toothed belt pulley, the two areas of the at least one groove separated from each other by the radial plane can have different widths in the circumferential direction in at least one section according to a further preferred configuration. The width can, for example, extend from the radial plane to one tooth flank in each case at the height of a diameter in the circumferential direction.

According to a further preferred embodiment, the two tooth flanks of the at least one groove, which are separated from each other by the radial plane, can be shaped differently concave. The differently concave shaped sections lie in particular on a diameter or in an area of the same diameter. In other words, the differently concave sections lie opposite each other in the circumferential direction in a groove.

Differently concave tooth flanks can be understood to mean that a tooth flank of one area of the groove divided by the radial plane has a different curvature, for example a different curvature radius, than the tooth flank of the other area of the groove divided by the radial plane. The differently concave sections of the two tooth flanks lying opposite each other in a groove are preferably at the same diameter, for example at half the tooth height in each case. In particular, the two tooth flanks lying opposite each other in the groove can be curved to different degrees at at least one point on the same diameter.

A concave tooth flank can be indented inwards, in the direction of the tooth. The indentation can form an undercut. This can mean that a radius beam emanating from the center of the toothed belt pulley, which touches the lowest point of the recess in the circumferential direction, intersects the tooth tip at the tip circle of the toothed belt pulley. Only one of the tooth flanks lying opposite each other in a groove can be provided with an undercut. Alternatively, the two tooth flanks lying opposite each other in a groove can have different undercuts.

Alternatively or cumulatively, one of the two tooth flanks lying opposite each other in a groove can have an indentation or depression extending deeper into the tooth in the circumferential direction than the other of the two tooth flanks.

The tooth flank with a larger and/or deeper indentation or depression can be the tooth flank that is configured for the force transmission with the teeth of the toothed belt, for example in the area of a groove that is separated by the radial plane and is located on the side of the groove pointing in the direction of the torque to be transmitted.

The tooth flanks of the two areas of the groove or contours of the tooth flanks separated by the radial plane can comprise a transition in which the course of the tooth flanks or contours of the tooth flanks changes from convex to concave or from concave to convex. In particular, a mathematical sign of the curvature can change from plus to minus or vice versa at the transition. The transition can be arranged on the same or on a different diameter for both tooth flanks.

In particular, an indentation or undercut reliably prevents the teeth of the toothed belt pulley from running up without weakening the teeth of the toothed belt pulley at the tooth roots and tooth heads.

The sections lying opposite each other in a groove in the circumferential direction, which are of different concave shapes, can extend over the entire tooth height or only a part of the tooth height. In particular, the two sections configured with different concavities are located at least at half the tooth height or between half the tooth height and the tip circle diameter.

Half the tooth height can be understood as an average tooth height. The tooth height can correspond to approximately 50% of the difference between the tip circle diameter and the root circle diameter of the toothed belt pulley. The tip circle diameter may correspond to the diameter of the toothed belt pulley at a tip circle and the root circle diameter may correspond to the diameter of the toothed belt pulley at a root circle. The tip circle of the toothed belt pulley can run through the tooth heads and the root circle of the toothed belt pulley can run through the tooth roots of the teeth of the toothed belt pulley.

The problem introductorily mentioned is further solved by a belt drive for a bicycle, with at least one toothed belt pulley and with a toothed belt, wherein a pitch of the toothed belt is larger than a pitch of the toothed belt pulley. Such a belt drive is less susceptible to failure because it is easier for the teeth of the toothed belt to mesh or enter the grooves of the toothed belt pulley. Such a belt drive is therefore safer and more reliable.

The embodiments of the toothed belt pulley described above also apply to a belt drive comprising at least one such toothed belt pulley. Thus, a feature described above in the context of the toothed belt pulley can be a feature of the toothed belt pulley of the belt drive.

In order to reduce the load on the toothed belt and to ensure good force transmission between the toothed belt pulley and the toothed belt, the teeth of the toothed belt pulley can, according to an advantageous configuration, be in mesh with the teeth of the toothed belt via a wrap angle of at least approximately 45°, at least approximately 90° or at least approximately 135° extending along the circumferential direction of the toothed belt pulley when the belt drive is fully assembled or ready for operation. This feature can be realized as the teeth on the toothed belt may have a certain elasticity.

The wrap angle can extend along a circumferential direction of the toothed belt pulley. In the belt drive, approximately one eighth to one third of the number of teeth of the toothed belt pulley can be in mesh with the teeth (or the grooves) of the toothed belt in the operational state without load.

For example, the teeth of the toothed belt pulley may be considered to be in mesh with the teeth of the toothed belt when the teeth of the toothed belt enter the grooves of the toothed belt pulley by at least approximately 80% of the tooth height of the teeth of the toothed belt. The teeth of the toothed belt pulley may be considered to be in load-bearing mesh with the teeth of the toothed belt when a force and/or torque is transmitted between the teeth of the toothed belt pulley and the teeth of the toothed belt.

In a preferred configuration, the belt drive is configured such that the wrap angle through which the teeth of the toothed belt pulley mesh with the teeth of the toothed belt increases as the operating load increases. The operating load can be understood as a force that is applied to the toothed belt. The operating load can also correspond to a torque that the belt drive transmits. The operating load should be less than the intended permissible operating load with which the toothed belt can still be operated. In order to increase the space available in the grooves of the toothed belt pulley and to simplify the entry of the teeth of the toothed belt into the grooves of the toothed belt pulley when the belt drive is twisted, a flank clearance between the teeth of the toothed belt and the teeth of the toothed belt pulley can be greater than a flank clearance between the teeth of the toothed belt and the teeth of a toothed belt pulley specified by the profile geometry of the toothed belt.

The flank clearance can be defined as the difference between a width in the circumferential direction of a groove of the toothed belt pulley and a width in the circumferential direction of a tooth of the toothed belt. The width of a groove of the toothed belt pulley and the width of a tooth of the toothed belt may be defined at the height of the same diameter, in particular if the teeth of the toothed belt properly mesh in the grooves of the toothed belt pulley.

In a preferred configuration, the belt drive comprises an entry point at which the toothed belt runs into the toothed belt pulley and an exit point at which the toothed belt runs out of the toothed belt pulley, wherein a gap between the tooth flanks of the toothed belt pulley pointing in the circumferential direction towards the entry point and the tooth flanks of the toothed belt opposite these tooth flanks and pointing in the circumferential direction towards the exit point is reduced from the entry point to the exit point.

The aforementioned configuration and the following configurations relating to the gap relate in particular to the geometric conditions when the belt drive is brand-new or only slightly worn, for example has only reached 20% of its service life.

In the force-free state of the toothed belt in mesh with the toothed belt pulley, the wrap angle reduces a gap in the circumferential direction between the tooth flanks of the toothed belt pointing in one circumferential direction and the tooth flanks of the toothed belt pulley opposite these tooth flanks of the toothed belt, while in the other, opposite circumferential direction this gap is reduced for the other tooth flank of the toothed belt. If the torque to be transmitted from the toothed belt to the toothed belt pulley increases, the gaps between the tooth flanks of the toothed belt pointing in the direction of the torque and the opposite tooth flanks of the toothed belt pulley are reduced until all tooth flanks are in contact with each other and the toothed belt transmits the torque over the entire wrap angle.

For example, the gap between the tooth flanks of the toothed belt pulley pointing in the circumferential direction towards the entry point and the tooth flanks of the toothed belt opposite these tooth flanks pointing in the circumferential direction towards the exit point is reduced from the entry point to the exit point. Conversely, the gap between the tooth flanks of the toothed belt pulley pointing in the circumferential direction towards the exit point and the tooth flanks of the toothed belt opposite these tooth flanks and pointing in the circumferential direction towards the entry point increases from the entry point to the exit point. The direction of rotation of the toothed belt pulley or the direction of the torque to be transmitted from the toothed belt to the toothed belt pulley is thereby directed in the circumferential direction from the entry point to the exit point.

In one configuration, there can be both a gap between the tooth flanks of the toothed belt pulley pointing in the circumferential direction towards the entry point and the tooth flanks of the toothed belt opposite these tooth flanks and pointing in the circumferential direction towards the exit point, as well as a gap between the tooth flanks of the toothed belt pulley pointing in the circumferential direction towards the exit point and the tooth flanks of the toothed belt opposite these tooth flanks and pointing in the circumferential direction towards the entry point.

In another configuration, in the force-free state of the belt drive, only the first three to five tooth flanks of the toothed belt, which are located at the exit point of the toothed belt pulley and point in the circumferential direction towards the exit point, can in each case abut the opposite tooth flanks of the toothed belt pulley, which point in the circumferential direction towards the entry point. The remaining tooth flanks of the toothed belt pointing in the circumferential direction towards the exit point are spaced apart from the respective opposite tooth flanks of the toothed belt pulley pointing in the circumferential direction towards the entry point. In the force-free state, the torque is therefore only transmitted from the toothed belt to the toothed belt pulley by the first three to five tooth flanks of the toothed belt located at the exit point of the toothed belt pulley. Similar conditions can exist at the entry point: in the force-free state of the belt drive, only the first three to five tooth flanks of the toothed belt located at the entry point of the toothed belt pulley and pointing in the circumferential direction towards the exit point can abut the opposite tooth flanks of the toothed belt pulley. As the torque to be transmitted increases, the number of tooth flanks of the toothed belt that abut the toothed belt pulley in the circumferential direction towards the exit point increases. The wrap angle over which the torque is transmitted—the “load-bearing” wrap angle-increases. The wrap angle is measured in the circumferential direction from the entry point towards the exit point of the toothed belt. The direction in which the load-bearing wrap angle increases can be opposite to the direction of rotation of the toothed belt pulley. The wrap angle can be measured in the circumferential direction starting from the exit point as the zero point. The exit point can be located at different positions on the toothed belt in different load situations or when the toothed belt is subjected to different forces. For example, the zero point of the wrap angle can be arranged at different positions on the toothed belt in different load situations.

According to a further preferred embodiment, the belt drive can be configured for the transmission of a force or torque from a driving toothed belt to a driven toothed belt pulley, in particular for a two-wheeled vehicle, and can comprise
tooth flanks of the driving toothed belt which can enter into meshing connection with a driven toothed belt pulley during operation,
tooth flanks of the driven toothed belt pulley, which can enter into meshing connection with the driving toothed belt during operation, and
a force which is transmitted from the load side of the driving toothed belt via the tooth flanks of the driving toothed belt to the tooth flanks of the driven toothed belt pulley.

Within the meshing connection, a number of force-transmitting tooth flanks of the driving toothed belt and tooth flanks of the driven toothed belt pulley can lie opposite one another in pairs and be in contact. Within the meshing connection, a number of non-force-transmitting tooth flanks of the driving toothed belt and non-force-transmitting tooth flanks of the driven toothed belt pulley can also lie opposite each other in pairs and not be in contact. During operation, the belt drive can be brought into a lightly loaded state, in which the force has a low value, in which the belt drive comprises a small number of force-transmitting tooth flanks and a large number of non-force-transmitting tooth flanks. The belt drive can be brought into at least one intermediate state in which the force has an average value, in which the belt drive comprises an average number of force-transmitting tooth flanks and an average number of non-force-transmitting tooth flanks. Furthermore, the belt drive can be brought into a highly loaded state, in which the force has a high value, in which the belt drive comprises a high number of force-transmitting tooth flanks and a small number of non-force-transmitting tooth flanks.

A low value of the force can, for example, be understood as a value below approximately 5% of the breaking load of the toothed belt. An average value of the force can, for example, be between approximately 5% and approximately 30% of the breaking load of the toothed belt. A high value of the force can be understood to mean, for example, values above approximately 30% of the breaking load of the toothed belt.

The breaking load can be understood as the tensile force at which the toothed belt breaks.

A high-quality toothed belt for a bicycle usually has a breaking load of approximately 12000 N.

A low value for the force of a toothed belt can be understood as a value between approximately 100 N and 600 N, for example. An average value for the force of a toothed belt can be between approximately 600 N and 3600 N, for example. A high force value for a toothed belt can be understood as a value above approximately 3600 N.

A small number of force-transmitting tooth flanks of the driving toothed belt and tooth flanks of the driven toothed belt pulley can be, for example, between approximately 10% and approximately 20%, an average number, for example, between approximately 20% and 35%, and a high number, for example, more than approximately 35% of the total number of teeth that the driven toothed belt pulley comprises.

A small number of non-force-transmitting tooth flanks of the driving toothed belt and tooth flanks of the driven toothed belt pulley can be, for example, between approximately 10% and approximately 20%, an average number, for example, between approximately 20% and approximately 35%, and a high number, for example, more than approximately 35% of the total number of teeth that the driven toothed belt pulley comprises.

A driven toothed belt pulley on a bicycle usually has between approximately 20 and approximately 40 teeth.

The term “approximately” can correspond to a deviation of +-10%.

The problem introductorily mentioned is further solved by a bicycle, in particular an electric bicycle, wherein the bicycle comprises a toothed belt pulley according to the invention and/or a belt drive according to the invention. Such a bicycle is particularly reliable and safe.

According to an advantageous configuration, one or the toothed belt pulley can be arranged in the area of a bottom bracket of the bicycle and/or one or the toothed belt pulley can be arranged in the area of a wheel hub of the bicycle. Such a configuration further increases the reliability and safety of the bicycle, as the driven and/or the driving toothed belt pulley interacts or interact with the toothed belt with particularly low failure rates.

In one configuration, only the driven toothed belt pulley is configured according to the invention. The driven toothed belt pulley can be arranged on the wheel hub, in particular on a rear wheel hub of the bicycle. If several driven toothed belt pulleys are present, in one embodiment, each of the driven toothed belt pulleys can be configured according to the invention. A driven toothed belt pulley can be understood to be an output-side toothed belt pulley.

The wheel hub is preferably the rear wheel hub, however it can also be a front wheel hub. The bicycle can also have a motor and/or gear unit that can be connected or is connected to at least one toothed belt pulley of the belt drive in a torque-transmitting manner. The motor and/or gear unit can, for example, be arranged in the area of the bottom bracket or directly on the bottom bracket or comprise the bottom bracket. Of course, the bicycle can also be provided with a hub gear and/or hub motor or the motor and/or gear unit can be arranged on a wheel hub.

In order to make the bicycle particularly suitable for riding on uneven terrain, the bicycle can comprise a suspension rear triangle according to a preferred configuration. Preferably, the bicycle is configured as a full suspension bike.

The problem introductorily posed is further solved by a kit for a belt drive, with at least two toothed belt pulleys configured as described above for toothed belts with the same predetermined pitch and toothing geometry, wherein the toothed belt pulleys comprise different numbers of teeth and different tip circle diameters, and wherein the toothed belt pulleys each comprise a pitch which is in each case smaller than the pitch of the toothed belt. Particularly in bicycle applications, belt drives usually have several toothed belt pulleys of different sizes. The toothed belt pulleys can be interchanged, for example, in order to realize belt drives with different transmission ratios. The different transmission ratios are reflected in different meshing conditions, for example a different wrap angle. The different configurations of the toothed belt pulleys allow them to be adapted to the different meshing conditions in order to optimally prevent mesh failures.

For example, a toothed belt pulley for a toothed belt pinion can have a smaller tip circle diameter than a toothed belt pulley for a toothed belt wheel. The kit provides these differently sized toothed belt pulleys flexibly. At the same time, each of the toothed belt pulleys in the kit is advantageous on its own, as their smaller pitch compared to the pitch of the toothed belt improves meshing.

In one configuration, the pitches of at least two toothed belt pulleys, preferably the pitches of all toothed belt pulleys in the kit, can be identical. In another configuration, toothed belt pulleys with different numbers of teeth have different toothing, in particular different pitches.

When a kit is mentioned above, not all of the toothed belt pulleys in the kit are usually installed in the bicycle. The user of the bicycle or the employees of a bicycle workshop are able to adapt the properties of the belt drive to the current requirements due to the features of the kit.

### BRIEF DESCRIPTION OF THE DRAWINGS

In the following, embodiments are explained in more detail with reference to the attached figures. Individual features present in the embodiment below may be omitted if, according to the above embodiments, the technical effect associated with this feature is not important. Conversely, a feature described above but not present in an embodiment below can be added to the embodiment if the technical effect associated with this feature is important for a particular application.

In the following, the same reference signs are used for elements that correspond to each other in terms of structure and/or function.

It is shown by:

FIG. 1 a schematic sectional view of a toothed belt pulley and a toothed belt according to a possible embodiment;

FIG. 2 a schematic sectional view of an asymmetrical groove of a toothed belt pulley according to a possible embodiment;

FIG. 3 a schematic sectional view of an asymmetrical groove of a toothed belt pulley according to a further possible embodiment;

FIG. 4 a schematic sectional view of an asymmetrical groove of a toothed belt pulley according to a further possible embodiment;

FIG. 5 a schematic sectional view of an asymmetrical groove of a toothed belt pulley according to a further possible embodiment;

FIG. 6 a schematic sectional view of a belt drive according to a possible embodiment;

FIG. 7 a schematic sectional view of the belt drive shown in FIG. 6 in a different operating state;

FIG. 8 a schematic perspective view of a bicycle according to a possible embodiment; and

FIG. 9 a schematic sectional view of a kit according to a possible embodiment.

### DETAILED DESCRIPTION

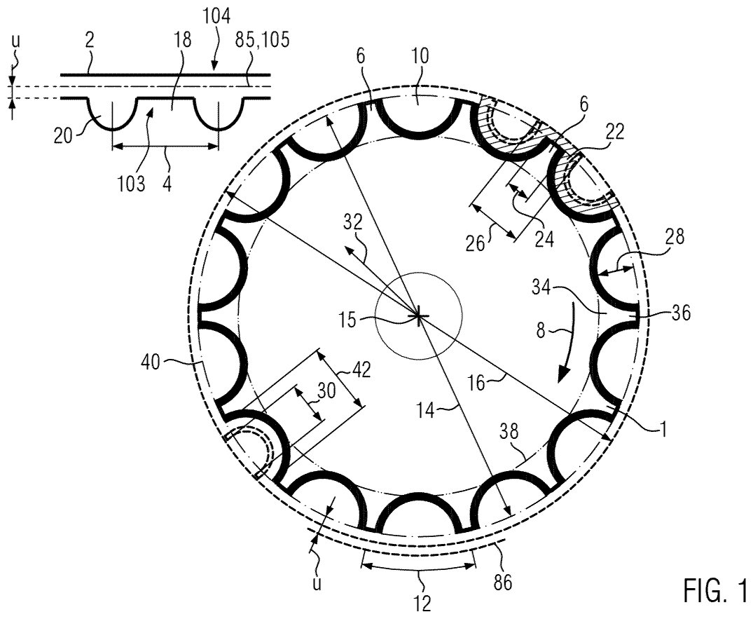

FIG. 1 shows purely by way of example a toothed belt pulley 1 and a section of a toothed belt 2 with a predetermined pitch 4 and a pitch line 85. The toothed belt pulley 1 has teeth 6, which are arranged along a circumferential direction 8 of the toothed belt pulley 1 on the toothed belt pulley 1, and grooves 10, which are arranged in the circumferential direction 8 of the toothed belt pulley 1 between adjacent teeth 6 of the toothed belt pulley 1 in each case. The toothed belt pulley 1 has a pitch 12 that is smaller than the pitch 4 of the toothed belt 2. In the embodiment shown in FIG. 1, the pitch 12 of the toothed belt pulley 1 is measured as the arc length on the pitch circle diameter 86. The shape of the teeth 6 and grooves 10 of the toothed belt pulley 1 is not fixed to the shape of the teeth 6 and grooves 10 shown only schematically in FIG. 1.

The toothed belt pulley 1 has an (actual) tip circle diameter 14, which in the embodiment shown is smaller than a (theoretical) tip circle diameter 16, which would actually be predetermined by the profile geometry of the toothed belt 2. The profile geometry of the toothed belt 2 determines parameters that characterize the shape of the grooves 18 and teeth 20 of the toothed belt 2. The tip circle diameter 16, which is predetermined by the profile geometry of the toothed belt 2, is shown in FIG. 1 purely by way of example and not to scale as a dashed line. The tip circle diameter 16 is determined starting from a center 15 of the toothed belt pulley 1 around which the toothed belt pulley 1 rotates. In the embodiment shown, the actual pitch 12, which is smaller than that of the toothed belt 2, is measured as an arc length on the pitch circle diameter 86. The pitch circle diameter 86 can be calculated by adding the (actual) tip circle diameter 14 and a double pitch line distance u. The pitch line distance u can be predetermined by the technical design of the toothed belt 2. The pitch line distance u can be measured between two teeth 20 of the toothed belt 2 and, in particular, at the point at which a distance between a belt back 104 and a belt running surface 103 is minimal. The pitch line distance u can correspond to the distance between the neutral fiber of the tensile member 105 in the toothed belt 2 and the belt running surface 103. The distance can be measured perpendicular to the belt running surface 103 and/or perpendicular to the neutral fiber of the tensile member 105.

As can be seen from FIG. 1, the teeth 6 of the toothed belt pulley 1 can be narrower, at least in sections, in the circumferential direction 8 than the teeth 22 actually predetermined by the profile geometry of the toothed belt 2. The teeth 6 of the toothed belt pulley 1 can have a width 24 in the circumferential direction 8 which is narrower than a width 26 of the teeth 6 predetermined by the profile geometry of the toothed belt 2. In the embodiment shown, the teeth 6 have a smaller width 24 along their entire tooth height 28 in relation to the circumferential direction 8 than the teeth 22 specified by the profile geometry of the toothed belt 2, the contour of which is also shown in FIG. 1 purely by way of example as a dashed line. The tooth height 28 can represent a distance in a radial direction 32 of the toothed belt pulley 1 between a tooth root 34 and a tooth head 36 of the teeth 6 of the toothed belt pulley 1 or a distance in radial direction 32 between a root circle 38 and a tip circle 40 of the toothed belt pulley 1.

The grooves 10 of the exemplarily shown toothed belt pulley 1 in FIG. 1 have a width 42 in the circumferential direction 8. The width 42 in circumferential direction 8 of the grooves 10 of the toothed belt pulley 1 need not, as shown in FIG. 1, be greater over the entire tooth height 38 than a width 30 of the grooves 10 predetermined by the profile geometry of the toothed belt 2. Thus, according to another configuration, the grooves 10 of the toothed belt pulley 1 can also have a greater width 42 than the width 30 actually required by the profile geometry of the toothed belt pulley 2 only in the area of the tooth root 34 of the teeth 6 of the toothed belt pulley 1 or in another section of the teeth 6 of the toothed belt pulley 1.

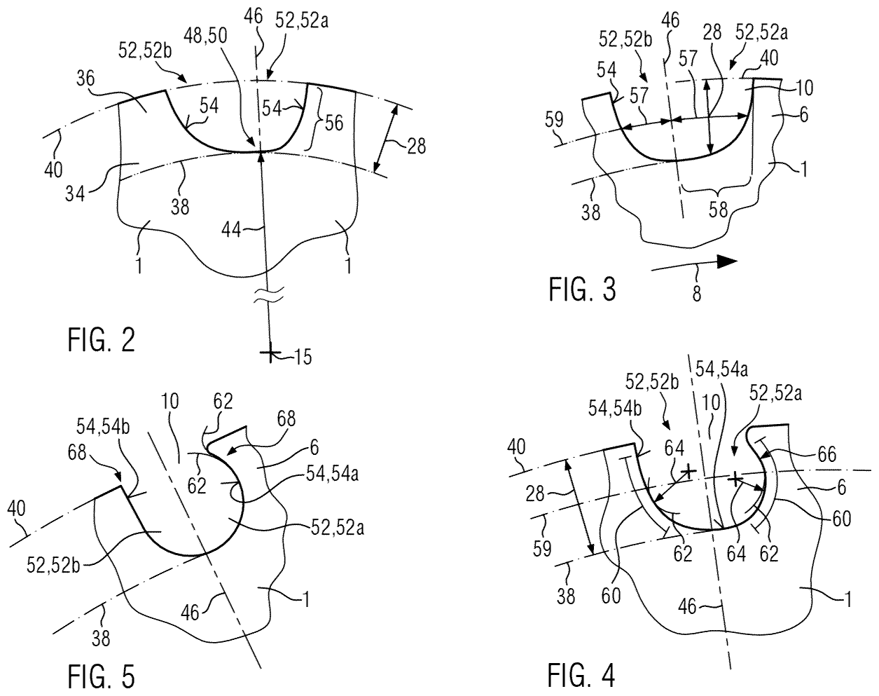

As the schematic sectional view shown in FIG. 2 shows, at least one groove 10 of the toothed belt pulley 1 can be configured asymmetrically. In the embodiment shown, the groove 10 is asymmetrical with respect to a radial plane 46, which runs through a point 48 of the groove 10 that lies on the smallest diameter or radius 44. As can be seen further on, this point 48 can correspond to an apex 50 of the groove 10. The radial plane 46 passes through the center 15 of the toothed belt pulley 1 and extends in a radial and axial direction.

The radial plane 46 can divide the at least one groove 10 into two areas 52 or 52a, 52b. One of the two tooth flanks 54, which lie opposite each other in the groove 10, is located in each area 52a, 52b.

As can be seen from FIG. 2, a tooth flank 54 arranged in one area 52a can be steeper in relation to the radial plane 46 in at least one section 56 than the tooth flank 54 arranged in the other area 52b. In the embodiment shown, the tooth flank 54 of one area 52, 52a is steeper along the entire tooth height 28 than the tooth flank 54 of the other area 52, 52b. Consequently, the section 56, in which the tooth flanks 54 extend at different steepnesses, extends in the embodiment shown from the tooth root 34 to the tooth head 36 of the tooth flank 54 or from the root circle 38 of the toothed belt pulley 1 to the tip circle 40 of the toothed belt pulley 1. Of course, according to another configuration, the section 56 can, for example, also extend from the tooth head 36 in the direction of smaller radii or from the tooth root 34 in the direction of larger radii of the toothed belt pulley 1.

FIG. 3 shows a groove 10 of the toothed belt pulley 1 which is asymmetrical with respect to the radial plane 46, wherein the two areas 52, 52a, 52b of the groove 10 are of different widths in a section 58 in the circumferential direction 8. In the embodiment shown, the section 58, in which the two regions are of different widths in the circumferential direction 8, extends from the root circle 38 of the toothed belt pulley 1 to the tip circle 40. According to another configuration, the section 58 can of course also extend between two other diameters or radii of the toothed belt pulley 1. For example, the section 58 can extend from a larger diameter than that of the root circle 38 to the tip circle 40 of the toothed belt pulley 1, so that the two areas 52, 52a, 52b have different widths along the entire tooth flanks 54. The width 57 is preferably measured in the circumferential direction 8 along a diameter 59 from the radial plane 46 to the tooth flank 54.

The embodiment shown in FIG. 4 shows a groove 10 asymmetrical with respect to the radial plane 46, the tooth flanks 54 of the two areas 52, 52a, 52b of which are shaped differently concave in a section 60.

The radial plane 46 divides the asymmetrical groove 10 into one area 52, 52a with a first tooth flank 54, 54a and the other area 52b with a second tooth flank 54, 54b. In the embodiment shown in FIG. 4, the first tooth flank 54, 54a is more concave or more strongly concave in the section 60 than the second tooth flank 54, 54b. As can be seen further, the first tooth flank 54, 54a can have a greater curvature 62, in particular a smaller curvature radius 64, in the section 60 than the second tooth flank 54, 54b.

As can be further seen from FIG. 4, the at least in sections more concave shape of a tooth flank 54 can mean that the tooth flank 54 with the at least in sections more concave shape has an indentation or depression 66. In the embodiment shown, the first tooth flank 54, 54a has such a depression 66 in the first area, which extends in the direction of a tooth center 68 of the tooth 6 with the first tooth flank 54, 54a related to the circumferential direction 8. Instead of or in addition to the depression 66, the tooth flank 54, 54a may have a rebound, a dent, a recess and/or an indentation.

In the embodiment shown, the section 60 extends at the height of half the tooth height 28 of the teeth 6 of the toothed belt pulley 1, however not as far as the tip circle 40 and not as far as the root circle 38 of the toothed belt pulley 1. According to other configurations, the section 60 can also extend further in the direction of larger radii of the toothed belt pulley 1, in particular as far as the tip circle 40 of the toothed belt pulley 1. It is also conceivable that the section 60 extends in the direction of smaller radii of the toothed belt pulley 1, in particular as far as the root circle 38 of the toothed belt pulley 1. In a further configuration, the concave section 60 can extend from the root circle 38 to the tip circle 40.

As can be seen in FIG. 5, the tooth flank 54 of at least one area 52, 52a, 52b of the asymmetrical groove 10 can have a transition 68, in which the tooth flank 54 changes from a concave to a convex course or from a convex course to a concave course. At the transition 68, the curvature 62 of the tooth flank 54, in particular the sign of the curvature 62, can change. In the embodiment shown in FIG. 5, the tooth flanks 54, 54a, 54b of both areas 52, 52a, 52b have such a transition 68. The transitions 68 of the tooth flanks 54, 54a, 54b of both areas 52, 52a, 52b do not have to be at the height of the same radius, as shown purely by way of example in FIG. 5. Rather, the transitions 68 of the tooth flanks 54, 54a, 54b can also be arranged at different radii. For example, the transition 68 of one area 52, 52a can be arranged closer to the tip circle 40 of the toothed belt pulley 1 than a transition 68 of the other area 52, 52b.

The different asymmetries of the grooves 10, which are described separately in connection with FIGS. 2 to 5 for the sake of simplicity, can of course be combined with each other as desired. Some asymmetries can also be combined with each other, for example an asymmetry in the curvature of the opposing tooth flanks can be accompanied by an asymmetry in the distance between tooth flank 54 and radial plane 46 on a diameter 59.

In the following, a belt drive 70 according to the invention with a toothed belt pulley 1 and a toothed belt 2, as described above, is described purely by way of example according to possible configurations. The belt drive 70 can have more than one, for example two, toothed belt pulleys 1. At least one toothed belt pulley 1 is then configured according to the invention, wherein the at least one toothed belt pulley 1 can in particular be one or the output-side toothed belt pulley 1.

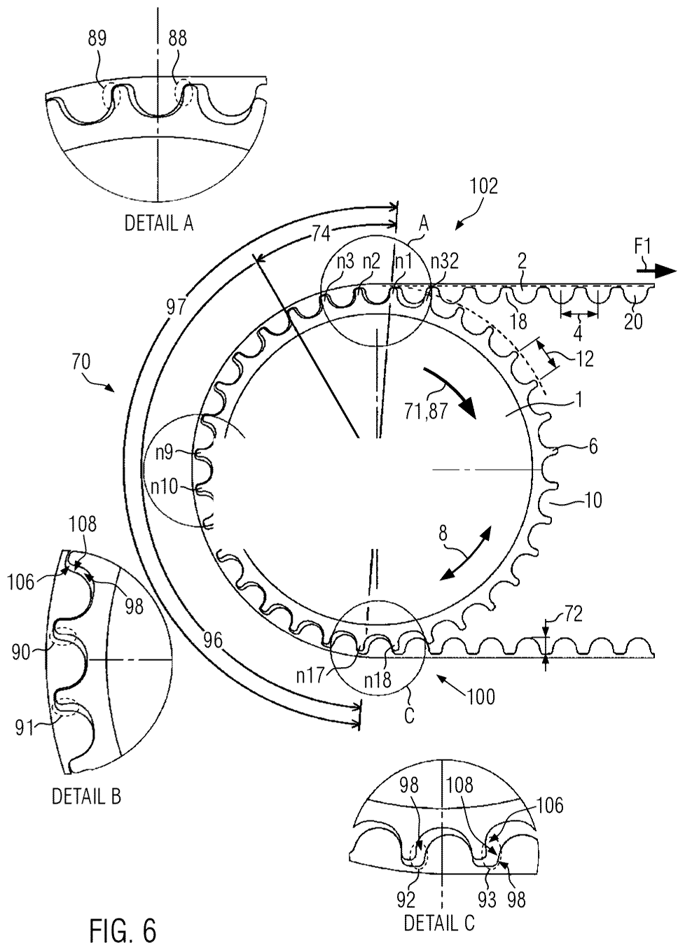

In the embodiment shown in FIG. 6, the belt drive 70 comprises the toothed belt pulley 1 and the toothed belt 2. The pitch 4 of the toothed belt 2 of the belt drive 70 is always greater than the pitch 12 of the toothed belt pulley 1 or the pitches 12 of the toothed belt pulleys 1. If at least two toothed belt pulleys 1 are provided, their pitches 12 do not necessarily have to be identical as long as the pitch 12 of at least one toothed belt pulley 1 is smaller than the specified pitch 4 of the toothed belt 2 of the belt drive 70. In order to maintain the transmission power of the toothed belt pulley 1 configured according to the invention, the pitch 12 of the toothed belt pulley 1 should preferably be reduced by no more than 2.5%, however by more than 0.5% in relation to the pitch 4 of the toothed belt 2. Further preferably, the pitch 12 of the toothed belt pulley 1 should not be reduced by more than 2%, however by more than 1% in relation to the pitch 4 of the toothed belt 2.

In the configuration shown in FIG. 6, the teeth 20 of the toothed belt 2 are in engagement with the teeth 6 of the toothed belt pulley 1. In some configurations, the force F1 in the toothed belt 2 can cause the toothed belt pulley 1 into rotation 87. A torque 71 is then transmitted under load, so that the teeth 20 of the toothed belt 2 are in torque-transmitting mesh with the teeth 6 of the toothed belt pulley 1. In the present embodiment, the teeth 20 of the toothed belt 2 enter the grooves 10 of the toothed belt pulley 1 almost completely, namely along the entire tooth height 72 of the teeth 20 of the toothed belt 2. In order for the teeth 20 of the toothed belt 2 to be considered to be in mesh with the grooves 10 of the toothed belt pulley 1, the teeth 20 of the toothed belt 2 do not necessarily have to enter the grooves 10 of the toothed belt pulley 1 along the entire tooth height 72 of the teeth 20 of the toothed belt 2, as in the embodiment according to FIG. 6. Thus, according to other configurations, it may be sufficient for the teeth 20 of the toothed belt 2 to enter the grooves 10 of the toothed belt pulley 1 by at least about 80% of the tooth height 72 of the teeth 20 of the toothed belt 2. The terms “engage”, “immerse” or “penetrate” may be used synonymously with the term “enter”.

As can be seen in detail A in FIG. 6, the first, for example the first three teeth n1, n2 and n3 of the toothed belt pulley 1 enter completely into the grooves 18 of the toothed belt 2 and transmit the main part of the force F1 to the toothed belt pulley 1. In the embodiment shown, the first three teeth n1, n2 and n3 are arranged in the area of an exit point 102 of the belt drive 70, at which the toothed belt 2 runs out of the toothed belt pulley 1 or runs off it. Similarly, the belt drive 70 also has an entry point 100 at which the toothed belt 2 enters the toothed belt pulley 1.

Since the force F1 is relatively low, the toothed belt 2 has only a small transmission surface 88 at the first tooth mesh n1 and likewise only a small transmission surface 89 at the second tooth mesh n2. Due to the different pitches 12, 4 of the toothed belt pulley 1 and the toothed belt 2, only a few teeth 6 of the toothed belt pulley 1 are in force-transmitting contact with teeth 20 of the toothed belt 2. Considering detail B from FIG. 6, it can be seen that the non-force-transmitting tooth flanks 106 of the toothed belt pulley 1 are no longer in contact with the non-force-transmitting tooth flanks 108 of the toothed belt 2. There is a gap 98 extending in the circumferential direction 8 between the non-force-transmitting tooth flanks 108 (but actually intended for force transmission) of the toothed belt 2 and the non-force-transmitting tooth flanks 106 (but actually intended for force transmission) of the toothed belt pulley 1. The transmission surface 90 at the ninth tooth mesh n9 and the transmission surface 91 at the tenth tooth mesh n10 are not under surface pressure. Considering detail C from FIG. 6, it can be seen that the non-force-transmitting tooth flanks 106 of the toothed belt pulley 1 are no longer in contact with the non-force-transmitting tooth flanks 108 of the toothed belt 2, but are spaced apart by the gap 98. Compared to detail B, the gap 98 between the non-force-transmitting tooth flanks 106, 108 is even larger. The transmission surface 92 at the seventeenth tooth mesh n17 and the transmission surface 93 at the eighteenth tooth mesh n18 are not under surface pressure.

FIG. 6 schematically shows a configuration of the belt drive 70 according to the invention with the toothed belt 2 and the driven pulley 1, which rotates clockwise when the force F1 is applied to the toothed belt 2. In this illustration, the behavior of the belt drive 70 is shown when only a small force F1, for example a force F1 of 150 to 300 Newton, is applied to the toothed belt 2. No relevant deformations of the teeth 20 of the toothed belt 2 take place at these small forces F1. These relatively low forces F1 can easily be transmitted by just a few teeth, for example by the teeth n1, n2, n3.

In this advantageous embodiment, the teeth 20 of the toothed belt 2 are in force-transmitting mesh with the teeth 6 of the toothed belt pulley 1 via a load-bearing wrap angle 74. Due to the flexibility of the teeth 20 of the toothed belt 2, the load-bearing wrap angle 74 increases as soon as the load F1 is increased. Thus, in an advantageous configuration, the toothed belt pulley 1 can be configured such that the load-bearing wrap angle 74 increases at high and very high operating loads, in particular up to the value of the wrap angle 97. Without any applied force F1 or without any pretension on the belt drive 70, the load-bearing wrap angle 74 can be zero, since only a single tooth is engaged.

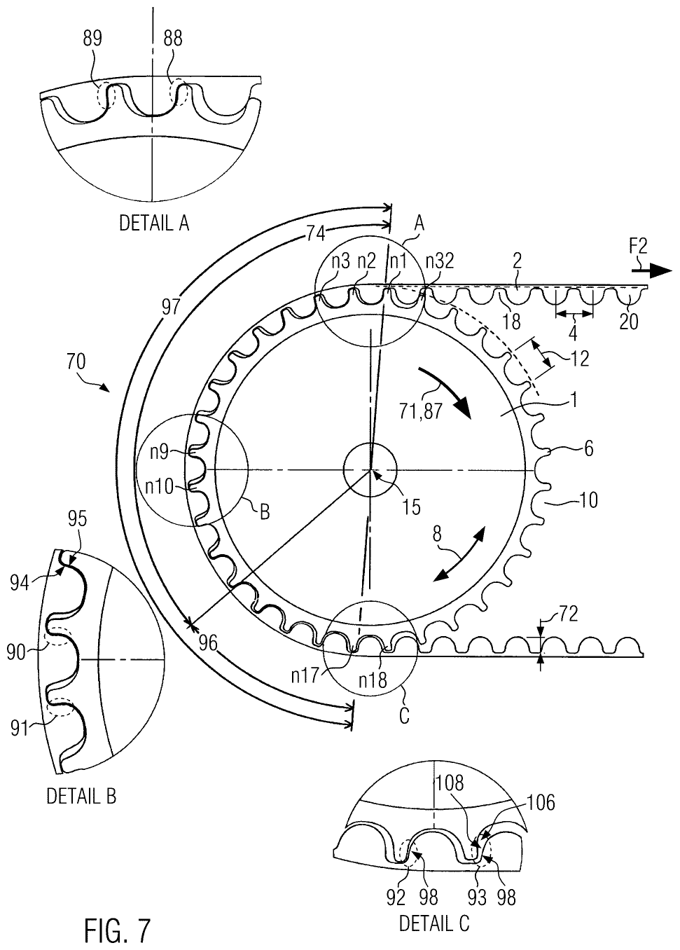

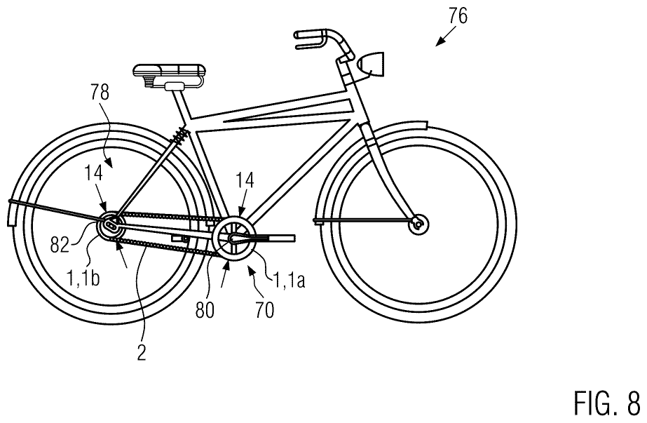

The structure of the configuration of the belt drive 70 shown in FIG. 7 essentially corresponds to the structure of the belt drive 70 shown in FIG. 6. However, the toothed belt 2 is subjected to a force F2 that is greater than the force F1 acting on the toothed belt 2 in the configuration shown in FIG. 6. As a result of the greater force F2, the toothed belt 2 is in force-transmitting mesh with the teeth 6 of the toothed belt pulley 1 via a larger load-bearing wrap angle 74 than the toothed belt 2 of the embodiment shown in FIG. 6, which is subjected to the lower force F1. As can be seen in detail A of FIG. 7, the teeth n1, n2 of the toothed belt 2 are in force-transmitting mesh with the teeth 6 of the toothed belt pulley 1 via larger transmission surfaces 89, 90 than is the case in the embodiment shown in FIG. 6.

Detail B in FIG. 7 shows that the force—transmitting tooth flanks 94 of the toothed belt pulley 1—in contrast to the non-force-transmitting tooth flanks 106, 108 shown in detail B of FIG. 6—are in contact with the force-transmitting tooth flanks 95 of the toothed belt 2. The transmission surface 90 at the ninth tooth mesh n9 and the transmission surface 91 at the tenth tooth mesh n10 are consequently under surface pressure, so that part of the force F2 is transmitted there.

As can be seen from detail C in FIG. 7, the non-force-transmitting tooth flanks 106 of the toothed belt pulley 1—like the non-force-transmitting tooth flanks 106, 108 in detail C in FIG. 6—are also not in contact with the non-force-transmitting tooth flanks 108 of the toothed belt 2 in the present embodiment. In particular, the non-force-transmitting tooth flanks 106 of the toothed belt pulley 1 are spaced apart from the non-force-transmitting tooth flanks 108 of the toothed belt 2 in the circumferential direction 8 by the gap 98. The transmission surface 92 on the seventeenth tooth mesh n17 and the transmission surface 93 on the eighteenth tooth mesh n18 are therefore also not under surface pressure. Compared to the configuration shown in detail C in FIG. 6, however, the gaps 98 between the non-force-transmitting tooth flanks 106, 108 are smaller. Furthermore, the load-bearing wrap angle 74 is larger and a non-load-bearing wrap angle 96 is smaller compared to the embodiment in FIG. 6. In the embodiment shown in FIG. 7, the load-bearing wrap angle 74 extends further along the circumferential direction 8 of the toothed belt pulley 1 compared to FIG. 6. In this exemplary configuration, the toothed belt 2 can run into the toothed belt pulley 1 without mesh failure even under high loads when the return strand is slack.

In the following, a bicycle 76 according to the invention is briefly described according to a possible embodiment with reference to FIG. 8. The bicycle 76 shown has a suspension rear triangle 78 and the belt drive 70 according to the invention according to a possible configuration. The belt drive 70 has two toothed belt pulleys 1 which are in mesh with the toothed belt 2. The toothed belt pulleys 1 can have different tip circle diameters 14. The pitches 12 of the toothed belt pulleys 1 are each smaller than the pitch 4 of the toothed belt 2 (different pitches 4, 12 cannot be seen in FIG. 8).

In the embodiment shown, a front toothed belt pulley 1, la is arranged on a bottom bracket 80 of the bicycle 76. The front toothed belt pulley 1, la can be driven on the bottom bracket 80 and can, for example, be subjected to a drive torque generated by muscle power and/or a motor. A rear toothed belt pulley 1, 1b can, as can be seen further in FIG. 8, be arranged in the area of a rear wheel hub 82 of the bicycle 76.

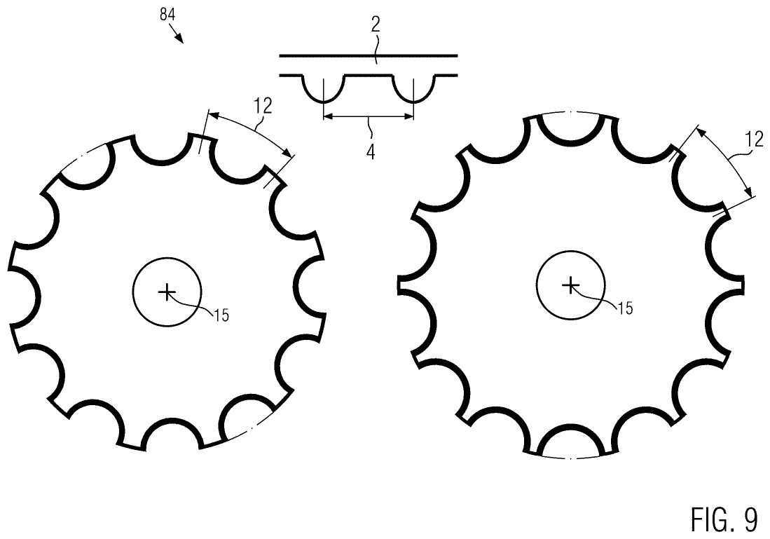

Finally, a kit 84 for a belt drive 70 is described briefly and purely by way of example with reference to FIG. 9. The kit 84 comprises, for example, two toothed belt pulleys 1. According to other configurations, however, the kit 84 may also comprise more than two, for example three or four toothed belt pulleys 1. The toothed belt pulleys 1 of the kit 84 are configured for use with the same toothed belt 2 of predetermined pitch 4 or an identical toothed belt 2.

The toothed belt pulleys 1 each have a different number of teeth and tip circle diameters 14. Both toothed belt pulleys 1 also have a pitch 12 which is in each case smaller than the predetermined pitch 4 of the toothed belt 2. The pitches 12 of the toothed belt pulleys 1 do not have to be the same, as in the embodiment shown in FIG. 9. Thus, the pitches 12 of the toothed belt pulleys 1 of the kit 84 can also be different from one another, as long as the pitches 12 of the toothed belt pulley 1 are each smaller than the predetermined pitch 4 of the toothed belt 2. For example, the pitch of the toothed belt pulleys 1 can depend on the number of teeth. Similarly, the groove shape of the toothed belt pulleys 1 can depend on the number of teeth.

Such a kit 84 can be used, for example, to change the transmission ratio of the belt drive 70.

Reference signs

| | |
|---|---|
| 1 | toothed belt pulley |
| 1a | front toothed belt pulley |
| 1b | rear toothed belt pulley |
| 2 | toothed belt |
| 4 | pitch of the toothed belt |
| 6 | teeth of the toothed belt pulley |
| 8 | circumferential direction |
| 10 | grooves of the toothed belt pulley |
| 12 | pitch of the toothed belt pulley |
| 14 | tip circle diameter of the toothed belt pulley |
| 15 | center |
| 16 | tip circle diameter predetermined by the profile geometry |
| 18 | grooves of the toothed belt, toothed belt grooves |
| 20 | teeth of the toothed belt, toothed belt teeth |
| 22 | teeth predetermined by the profile geometry |
| 24 | width of the of the tooted belt pulley |
| 26 | width of the teeth predetermined by the profile geometry |
| 28 | tooth height of the teeth of the toothed belt pulley |
| 30 | width of the grooves predetermined by the profile geometry |
| 32 | radial direction |
| 34 | tooth root |
| 36 | tooth head |
| 38 | root circle |
| 40 | tip circle |
| 42 | width of the grooves |
| 44 | smallest radius or diameter |
| 46 | radial plane |
| 48 | point |
| 50 | apex |
| 52 | areas |
| 52a | the one area |
| 52b | the other area |
| 54 | tooth flank |
| 54a | first tooth flank |
| 54b | second tooth flank |
| 56 | section with different steepnesses |
| 57 | width |
| 58 | section with different widths |
| 59 | diameter |
| 60 | section with differently concave tooth flanks |
| 62 | curvature |
| 64 | curvature radius |
| 66 | depression |
| 68 | transition |
| 70 | belt drive |
| 71 | torque |
| 72 | tooth height of the teeth of the toothed belt |
| 74 | load-bearing wrap angle |
| 76 | bicycle |
| 78 | suspension rear triangle |
| 80 | bottom bracket |
| 82 | rear wheel hub |
| 84 | kit |
| 85 | pitch line |
| 86 | pitch circle diameter |
| 87 | rotation |
| 88 | transmission surface at the first tooth mesh |
| 89 | transmission surface at the second tooth mesh |
| 90 | transmission surface at the ninth tooth mesh |
| 91 | transmission surface at the tenth tooth mesh |
| 92 | transmission surface at the seventeenth tooth mesh |
| 93 | transmission surface at the eighteenth tooth mesh |
| 94 | force-transmitting tooth flanks of the toothed belt pulley |
| 95 | force-transmitting tooth flanks of the toothed belt |
| 96 | non-load-bearing wrap angle |
| 97 | wrap angle |
| 98 | gap |
| 100 | entry point |
| 102 | exit point |
| 103 | belt running surface |
| 104 | belt back |
| 105 | tensile member |
| 106 | non-force-transmitting tooth flanks of the toothed belt pulley |
| 108 | non-force-transmitting tooth flanks of the toothed belt |
| F1, F2 | forces |
| n1, n2, | first, second, third, . . . tooth |
| n3, . . . | |
| u | pitch line distance |

1. A toothed belt pulley (1) for a toothed belt (2) with a predetermined pitch (4), wherein the toothed belt pulley (1) comprises teeth (6) arranged along a circumferential direction (8) of the toothed belt pulley (1) and grooves (10) arranged in the circumferential direction (8) between respectively adjacent teeth (6) of the toothed belt pulley (1), and wherein the toothed belt pulley (1) comprises a pitch (12) which is smaller than the pitch (4) of the toothed belt (2).

2. The toothed belt pulley according to claim 1, wherein the pitch (12) of the toothed belt pulley (1) is smaller than the pitch (4) of the toothed belt (2) by at least 0.5% and at most 2.5% of the pitch (4) of the toothed belt (2).

3. The toothed belt pulley (1) according to claim 1,
wherein the toothed belt pulley (1) comprises a tip circle diameter (14) which is smaller than the tip circle diameter (16) predetermined by the profile geometry of the toothed belt (2).

4. The toothed belt pulley (1) according to claim 1,
wherein the teeth (6) of the toothed belt pulley (1) are narrower, at least in sections along the circumferential direction (8), than teeth (22) predetermined by the profile geometry of the toothed belt (2).

5. The toothed pulley (1) according to claim 1, wherein the grooves (10) of the toothed belt pulley (1) comprise a width (42) in the circumferential direction (8) which, at least in the area of the tooth roots (34) of the teeth (6) of the toothed belt pulley (1), is greater than a width (30) of the grooves (10) predetermined by the profile geometry of the toothed belt (2).

6. The toothed belt pulley (1) according to claim 1,
wherein at least one groove (10) of the toothed belt pulley (1) is asymmetrical in each case with respect to a radial plane (46) extending through the point (48) of the respective groove (10) lying on the smallest diameter, and wherein the radial plane (46) divides the at least one groove (10) into two areas (52, 52a, 52b).

7. The toothed belt pulley (1) according to claim 6,
wherein the tooth flanks (54, 54a, 54b) in the two areas (52, 52a, 52b) have a different steepness with respect to the radial plane (46) in at least one section (56).

8. The toothed belt pulley (1) according to claim 6,
wherein the areas (52, 52a, 52b) of the at least one groove (10) are of different widths in at least one section (58) in the circumferential direction (8).

9. The toothed belt pulley (1) according to claim 6,
wherein the tooth flanks (54, 54a, 54b) in the two areas (52, 52a, 52b) of the at least one groove (10) are shaped differently concave in at least one section (60).

10. The toothed belt pulley (1) according to claim 9,
wherein the at least one section (60) extends at the height of an average tooth height (28) of the teeth (6) of the toothed belt pulley (1).

11. The toothed belt pulley (1) according to claim 9,
wherein the at least one section (60) extends further in the direction of larger radii of the toothed belt pulley (1).

12. A belt drive (70) for a bicycle (76), with at least one toothed belt pulley (1) and with a toothed belt (2), wherein a pitch (4) of the toothed belt (2) is greater than a pitch (12) of the toothed belt pulley (1).

13. The belt drive (70) according to claim 12,
wherein the belt drive (70) comprises an entry point (100), at which the toothed belt (2) runs into the toothed belt pulley (1), and an exit point (102), at which the toothed belt (2) runs out of the toothed belt pulley (1), wherein a gap (98) between the tooth flanks (94) of the toothed belt pulley (1) pointing in the circumferential direction (8) towards the entry point (100) and the tooth flanks (95) of the toothed belt (2) opposite these tooth flanks (94) and pointing in the circumferential direction (8) towards the exit point (102) is reduced from the entry point (100) to the exit point (102).

14. The belt drive (70) according to claim 12,
wherein a flank clearance between the teeth (20) of the toothed belt (2) and the teeth (6) of the toothed belt pulley (1) is greater than a flank clearance between the teeth (20) of the toothed belt (2) and the teeth (6) of a toothed belt pulley predetermined by the profile geometry of the toothed belt (2).

15. A bicycle (76), in particular electric bicycle, wherein the bicycle (76) comprises a toothed belt pulley (1) according to claim 1.

16. The bicycle (76) according to claim 15, wherein a toothed belt pulley (1) is arranged in the area of a bottom bracket (80) of the bicycle (76) and/or wherein a toothed belt pulley (1) is arranged in the area of a wheel hub (82) of the bicycle (76).

17. The bicycle (76) according to claim 15,
wherein the bicycle (76) comprises a suspension rear triangle (78).

18. A kit (84) for a belt drive (70), with at least two toothed belt pulleys (1) according to claim 1 for toothed belts (2) of the same predetermined pitch (4) and toothing geometry, wherein the toothed belt pulleys (1) comprise different numbers of teeth and different tip circle diameters (14), and wherein the toothed belt pulleys (1) each comprise a pitch (12) which is in each case smaller than the pitch (4) of the toothed belt (2).

19. A belt drive (70) according to claim 12 for the transmission of a force (F1, F2) or a torque from a driving toothed belt (2) to a driven toothed belt pulley (1), in particular for a two-wheeled vehicle, with
tooth flanks (95, 108) of the driving toothed belt (2), which can enter into meshing connection with a driven toothed belt pulley (1) during operation,
tooth flanks (94, 106) of the driven toothed belt pulley (1), which can enter into meshing connection with the driving toothed belt (2) during operation,
a force (F1, F2) which is transmitted from the load side of the driving toothed belt (2) via the tooth flanks (95) of the driving toothed belt (2) to the tooth flanks (94) of the driven toothed belt pulley (1),
wherein within the meshing connection a number of force-transmitting tooth flanks (95) of the driving toothed belt (2) and tooth flanks (94) of the driven toothed belt pulley (1) lie opposite one another in pairs and are in contact, and
wherein within the meshing connection a number of non-force-transmitting tooth flanks (108) of the driving toothed belt (2) and non-force-transmitting tooth flanks (106) of the driven toothed belt pulley (1) lie opposite one another in pairs and are not in contact,
wherein the belt drive (2) during operation can be brought
into a lightly loaded state, in which the force (F1, F2) has a low value, in which the belt drive (70) comprises a small number of force-transmitting tooth flanks (94, 95) and a large number of non-force-transmitting tooth flanks (106, 108), and
into at least one intermediate state, in which the force (F1, F2) has an average value, in which the belt drive (70) comprises an average number of force-transmitting tooth flanks (94, 95) and an average number of non-force-transmitting tooth flanks (106, 108), and into a highly loaded state in which the force (F1, F2) has a high value, in which the belt drive (70) comprises a high number of force-transmitting tooth flanks (94, 95) and a small number of non-force-transmitting tooth flanks (106, 108).
